(19) United States
(12) Patent Application Publication
(10) Pub. No.: US 2009/0113688 A1
(43) Pub. Date: May 7, 2009

(54) ASSEMBLY FAILURE PREVENTION DEVICE

(75) Inventors: Shingo Izuchi, Aichi (JP); Koichi Watanabe, Aichi (JP); Sakae Gotou, Aichi (JP); Toyoaki Tabata, Aichi (JP); Kiyonobu Nagaya, Aichi (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: KABUSHIKI KAISHA TOKAI-RIKA-DENKI-SEISAKUSHO, Aichi (JP)

(21) Appl. No.: 12/092,943

(22) PCT Filed: Jul. 13, 2006
(86) PCT No.: PCT/JP2006/314322

§ 371 Date: May 7, 2008

(30) Foreign Application Priority Data
Nov. 9, 2005 (JP) 2005-325188

(51) Int. Cl. B25B 27/14

(52) U.S. Cl. 29/281.1

(57) ABSTRACT

An assembly failure prevention device capable of effectively preventing assembly failure of assembly members onto a belt member. A tongue support device 20 of an assembly failure prevention device 10 includes a slide plate 40 having a fitting hole 42 conforming to the shape of a specific tongue plate 44. The slide plate 40 is guided by guide rail 28 and guide groove 34, and moves to a predetermined position for passing a webbing belt therethrough. If a wrong tongue plate 40 is fitted in the fitting hole 42, an insertion portion 50 of tongue plate 44 projects from the fitting hole 42. When the slide plate 40 moves in this state, the insertion portion 50 is interfered with by an end portion of the guide rail 28, and is dropped out of the slide plate 40.

### TECHNICAL FIELD

The present invention relates to an assembly failure prevention device for preventing the occurrence of assembly failure such as mounting of wrong members when assembling specified members onto a webbing belt of a seat belt device of a vehicle or other belt members.

### BACKGROUND ART

A so-called three-point seat belt device mounted on a vehicle (hereinafter, the three-point seat belt device is simply referred to as “seat belt device”) has a long band-shaped webbing belt. The webbing belt is stowed away with the base end side in its longitudinal direction being wound up on a spool (wind-up shaft) of a retractor (wind-up device) fixed to the car body at the lower side of a center pillar of the vehicle.

On the other hand, the leading end side in the longitudinal direction of the webbing belt is drawn out substantially in the upwards direction of the vehicle from the spool of the retractor. Corresponding to this webbing belt being drawn out upward, a slip joint is attached to the car body at the upper side of the center pillar. A slit-shaped insertion hole is formed in the slip joint, and the webbing belt is folded back on itself substantially in the downwards direction of the vehicle, passing through the insertion hole of the slip joint.

The leading end of the webbing belt folded back downward on itself passes through an insertion hole formed in an anchor plate and is folded back on itself, and is sewn on the base end side from the passing portion of the insertion hole. The anchor plate is fixed to the car body at the lower side of the center pillar.

Between the anchor plate and the slip joint, the webbing belt passes through a slit-shaped insertion hole formed in a tongue plate. The tongue plate is detachably fitted across a seat to a buckle provided at the opposite side of the retractor and anchor plate.

When a passenger sitting on the seat pulls the tongue plate and attaches the tongue plate to the buckle while pulling out the webbing belt wound up on the spool, the webbing belt confines the chest of the passenger between the tongue plate and the slip joint, so that the chest of the passenger is confined by the webbing belt between the tongue plate and slip joint.

When assembling such a seat belt device, for example, the retractor is assembled in the first place. Then the webbing belt is pulled out from the spool of the retractor, and the webbing belt is passed into insertion holes in the sequence of slip joint, tongue plate, and anchor plate. Passing through the insertion hole of the anchor plate, the webbing belt is folded back, and sutured by a suturing device (sewing machine) (see Japanese Patent Application Laid-Open No. 2002-307253 and Japanese Patent Application Laid-Open No. 10-76088 as examples of assembling devices used in such an assembling process).

Recently, seat belt devices are increasing in variety, and the slip joint, tongue plate, and anchor plate are formed in various shapes depending on the type of seat belt device.

As the variety is increasing, there is a fear that a wrong tongue plate or the like may be assembled in the seat belt device, and a wrong assembly may occur.

Furthermore, when the work of passing the webbing belt into insertion holes of slip joint, tongue plate and anchor plate is done continuously, the worker may fail to pass the webbing belt through any of the slip joint, tongue plate and anchor plate, and any of the slip joint, tongue plate and anchor plate may be missed, and a deficient assembly may occur.

To prevent such wrong assembly or deficient assembly or the like, for example, after the assembling process of these members, if there is a check to see if the members corresponding to the seat belt device are correctly assembled or not in the webbing belt, it is at least possible to prevent defective assemblies from being sent to the next process. However, such an inspection process is costly and does not contribute to a fundamental elimination of defects.

### DISCLOSURE OF THE INVENTION

In the light of the above facts, it is hence an object of the present invention to provide an assembly failure prevention device capable of effectively preventing occurrences of assembly failure of members to be assembled with a belt member.

An assembly failure prevention device as set forth in a first aspect of the invention is an assembly failure prevention device used in an assembling process of assembling an assembly member onto a belt member by inserting the belt member into the assembly members having insertion holes for inserting the belt member, comprising: a support body for supporting a specific assembly member, of plural types of the assembly members having outer shapes different from each other, in a state allowing the belt member to pass through the insertion hole, guide means for guiding the support body to a predetermined position that is the position on the passing track of the belt member at the time of passing the belt member into the insertion hole, and first regulating means for preventing the support body to move to the insertion position when a wrong assembly member different from the specific member has been mounted on the support body.

An assembly failure prevention device as set forth in a second aspect of the invention relates to the first aspect, in which the first regulating means includes an interference portion for interfering with a part of the wrong assembly member when the support body is guided by the guide means and moved to the predetermined position side, such that the support body is prevented from moving to the predetermined position side by the interference of the interference portion with a part of the wrong assembly member.

An assembly failure prevention device as set forth in a third aspect of the invention relates to the second aspect, in which the support body includes a fitting hole capable of accommodating the specific assembly member inside thereof and projecting outside at least one part of the wrong assembly member when the wrong assembly member is accommodated therein, such that the interference portion interferes with the part of the wrong assembly member projecting from the fitting hole.

An assembly failure prevention device as set forth in a fourth aspect of the invention relates to the third aspect, in which the interference portion interferes with the wrong assembly member mounted on the support body, and drops the wrong assembly member from the support body.

An assembly failure prevention device as set forth in a fifth aspect of the invention relates to the fourth aspect, in which the support body includes a fitting hole capable of accommodating the specific assembly member inside thereof, projecting outside at least one part of the wrong assembly member when the wrong assembly member is accommodated therein and moving the wrong assembly member in an interference direction of the interference portion with the wrong assembly member.

An assembly failure prevention device as set forth in a sixth aspect of the invention relates to the fifth aspect, further comprising second regulating means provided on the passing track of the belt member, for interfering with the belt member which is about to pass through the predetermined position when the support body supporting the assembly member has not yet reached the predetermined position, such that the belt member is prevented from passing through the predetermined position.

An assembly failure prevention device as set forth in a seventh aspect of the invention relates to the sixth aspect, in which the second regulating means includes a regulating member provided on the passing track of the belt member, the regulating member being moved out of the passing track by being pressed by the assembly member moving to the predetermined position.

An assembly failure prevention device as set forth in a eighth aspect of the invention relates to the fourth aspect, further comprising second regulating means provided on the passing track of the belt member, for interfering with the belt member which is about to pass through the predetermined position when the support body supporting the assembly member has not yet reached the predetermined position, such that the belt member is prevented from passing through the predetermined position.

An assembly failure prevention device as set forth in a ninth aspect of the invention relates to the eighth aspect, in which the second regulating means includes a regulating member provided on the passing track of the belt member, the regulating member being moved out of the passing track by being pressed by the assembly member moving to the predetermined position.

An assembly failure prevention device as set forth in a tenth aspect of the invention relates to the third aspect, further comprising second regulating means provided on the passing track of the belt member, for interfering with the belt member which is about to pass through the predetermined position when the support body supporting the assembly member has not yet reached the predetermined position, such that the belt member is prevented from passing through the predetermined position.

An assembly failure prevention device as set forth in an eleventh aspect of the invention relates to the tenth aspect, in which the second regulating means includes a regulating member provided on the passing track of the belt member, the regulating member being moved out of the passing track by being pressed by the assembly member moving to the predetermined position.

An assembly failure prevention device as set forth in a twelfth of the invention relates to the second aspect, in which the interference portion interferes with the wrong assembly member mounted on the support body, and drops the wrong assembly member from the support body.

An assembly failure prevention device as set forth in a thirteenth aspect of the invention relates to the twelfth aspect, in which the support body includes a fitting hole capable of accommodating the specific member inside thereof, projecting outside at least one part of the wrong assembly member when the wrong assembly member is accommodated therein, and moving the wrong assembly member in an interference direction of the interference portion with the wrong member.

An assembly failure prevention device as set forth in the fourteenth aspect of the invention relates to the thirteenth aspect, further comprising second regulating means provided on the passing track of the belt member, for interfering with the belt member which is about to pass through the predetermined position when the support body supporting the assembly member has not yet reached the predetermined position, such that the belt member is prevented from passing through the predetermined position.

An assembly failure prevention device as set forth in a fifteenth aspect of the invention relates to the fourteenth aspect, in which the second regulating means includes a regulating member provided on the passing track of the belt member, the regulating member being moved out of the passing track by being pressed by the assembly member moving to the predetermined position.

An assembly failure prevention device as set forth in a sixteenth aspect of the invention relates to the twelfth aspect, further comprising second regulating means provided on the passing track of the belt member, for interfering with the belt member which is about to pass through the predetermined position when the support body supporting the assembly member has not yet reached the predetermined position, such that the belt member is prevented from passing through the predetermined position.

An assembly failure prevention device as set forth in a seventeenth aspect of the invention relates to the sixteenth aspect, in which the second regulating means includes a regulating member provided on the passing track of the belt member, the regulating member being moved out of the passing track by being pressed by the assembly member moving to the predetermined position.

An assembly failure prevention device as set forth in an eighteenth aspect of the invention relates to the second aspect, further comprising second regulating means provided on the passing track of the belt member, for interfering with the belt member which is about to pass through the predetermined position when the support body supporting the assembly member has not yet reached the predetermined position, such that the belt member is prevented from passing through the predetermined position.

An assembly failure prevention device as set forth in a nineteenth aspect of the invention relates to the eighteenth aspect, in which the second regulating means includes a regulating member provided on the passing track of the belt member, the regulating member being moved out of the passing track by being pressed by the assembly member moving to the predetermined position.

An assembly failure prevention device as set forth in a twentieth aspect of the invention relates to the first aspect, further comprising second regulating means provided on the passing track of the belt member, for interfering with the belt member which is about to pass through the predetermined position when the support body supporting the assembly member has not yet reached the predetermined position, such that the belt member is prevented from passing through the predetermined position.

An assembly failure prevention device as set forth in a twenty first aspect of the invention relates to the twentieth aspect, in which the second regulating means includes a regulating member provided on the passing track of the belt member, the regulating member being moved out of the passing track by being pressed by the assembly member moving to the predetermined position.

An assembly failure prevention device as set forth in a twenty second of the invention is an assembly failure prevention device used in an assembling process of assembling an assembly member onto a belt member by inserting the belt member into the assembly member having insertion holes for inserting the belt member, comprising: (second) regulating means provided on the passing track of the belt member, for interfering with the belt member in a state in which the assembly member has not yet reached a predetermined position on the passing track, such that, as a result of the interference with the belt member, the belt member is prevented from passing through the predetermined position.

An assembly failure prevention device as set forth in a twenty third aspect of the invention relates to the twenty second aspect, in which the second regulating means includes a regulating member provided on the passing track of the belt member, the regulating member being moved out of the passing track by being pressed by the assembly member moving to the predetermined position.

When inserting the belt member into the insertion hole of the assembly member by using the assembly failure prevention device of the first aspect of the invention, the support body mounting the assembly member is moved to a predetermined position on the moving track of the belt member by the guide means. In this state, the belt member is passed through the insertion hole of the assembly member while the belt member is made to pass on the passing track.

Herein, the support body can support only a specific assembly member out of plural assembly members differing in shape. When a wrong member not conforming to the support body is mounted on the support body, and it is attempted in this state to move the support body to a predetermined position on the passing track of the belt member by being guided by the guide member, the support body mounting the wrong member is restricted in movement by the first regulating means.

Therefore, while a wrong member is mounted on the support body, the support body cannot be moved to the predetermined position, and hence the wrong member does not reach the predetermined position. It hence can prevent occurrences of assembly failure of allowing the belt member to pass through the insertion hole of a wrong member.

In the assembly failure prevention device of the second aspect of the invention, if it is attempted to move the support body to a predetermined position on the passing track of the belt member by being guided by the guide member with a wrong member not conforming to the support body mounted on the support body, the wrong member mounted on the support body is interfered with by the interference portion of the first regulating means.

Therefore, the interference portion interferes with the wrong member, and the movement of the support body mounting the wrong member is restricted, and it thereby can prevent occurrences of assembly failure of allowing the belt member to pass through the insertion hole of a wrong member.

In the assembly failure prevention device of the third aspect of the invention, a fitting hole is formed in the support body, and the assembly member is accommodated in this fitting hole. The fitting hole is formed corresponding to the outer shape of a specific support member, and if it is attempted to put a wrong member into the fitting hole, at least one part of the wrong member projects out from the fitting hole.

If it is attempted to move the support body to a predetermined position as being guided by the guide member with a wrong member projecting from the fitting hole, the interference portion interferes with the part of the member projecting from the fitting hole. As a result, the movement of the support body mounting the wrong member is restricted, and it thereby can prevent occurrences of assembly failure of allowing the belt member to pass through the insertion hole of a wrong member.

In the assembly failure prevention device of the fourth aspect of the invention, if it is attempted to move the support body to a predetermined position on the passing track of the belt member by being guided by the guide member with a wrong member not conforming to the support body mounted on the support body, the wrong member mounted on the support body is interfered with by the interference portion.

Further, when the interference portion interferes with the wrong member, the wrong member is dropped out of the support body. Therefore, the movement of the support body mounting the wrong member is restricted, and it thereby can prevent occurrences of assembly failure of allowing the belt member to pass through the insertion hole of a wrong member.

Moreover, as the wrong member is dropped out, it saves the labor of dismounting the wrong member from the support body. Therefore, if a wrong member is mounted on the support body by mistake, a decrease in work efficiency can be suppressed.

In the assembly failure prevention device of the fifth aspect of the invention, a fitting hole is formed in the support body, and the assembly member is accommodated in this fitting hole. The fitting hole is formed corresponding to the outer shape of a specific support member, and if it is attempted to put a wrong member into the fitting hole, at least one part of the wrong member projects out from the fitting hole.

If it is attempted to move the support body to a predetermined position by being guided by the guide member with a wrong member projecting out from the fitting hole, the interference portion interferes with the part of the member projecting out from the fitting hole. Further, the wrong member pressed by the interference portion is moved by the pressing force of the interference portion, and moves towards the outside of the support body, and in this way is dropped out of the support body It hence can prevent occurrences of assembly failure of allowing the belt member to pass through the insertion hole of a wrong member.

Moreover, as the wrong member is dropped out, it saves the labor of dismounting the wrong member from the support body. Therefore, if a wrong member is mounted on the support body by mistake, a decrease in work efficiency can be suppressed.

In the assembly failure prevention device of the sixth aspect of the invention, if a support body not supporting an assembly member thereon reaches a predetermined position on the passing track of the belt member and the belt member attempts to pass the predetermined position in this state, the belt member is interfered with by second regulating means. Hence, in this state, the belt member cannot pass the predetermined position. It hence can prevent occurrences of assembly failure such as allowing a belt member not assembled with a member to be sent to a subsequent process.

Moreover, if the wrong member is interfered with by the interference portion of the first regulating means and dropped out of the support body, there is a high probability that only the support body will reach the predetermined position. In the assembly failure prevention device of the invention, however, the belt member cannot pass the predetermined position when an assembly member is not mounted on the support body, and it hence can prevent occurrences of assembly failure of allowing a belt member without the assembly of the member to be sent to a subsequent process.

In the assembly failure prevention device of the seventh aspect of the invention, a regulating member for forming a second regulating means is provided on the passing track of the belt member. If the belt member attempts to pass the predetermined position before the assembly member reaches the predetermined position, the regulating member positioned on the passing track of the belt member is interfered with by the belt member. As a result, the belt member is restricted from passing the predetermined position.

On the other hand, when the assembly member is moved to the predetermined position, the regulating member is pressed by the assembly member, and by this pressing force, the regulating member is moved out of the passing track of the belt. In this state, if the belt member passes on the passing track, it is not interfered with by the regulating member. Hence, the belt member passes the predetermined position, and passes through the insertion hole of the assembly member.

In the assembly failure prevention device of the eighth aspect of the invention, if the support body without an assembly member mounted thereon reaches a predetermined position on the passing track of the belt member and the belt member attempts to pass the predetermined position in this state, the belt member is interfered with by second regulating means. Hence, in this state, the belt member cannot pass the predetermined position. It hence can prevent occurrences of assembly failure of allowing a belt member without the member assembled to be sent to a subsequent process.

Moreover, if a wrong member is interfered with by the interference portion of the first regulating means and dropped out of the support body, there is a high probability that only the support reaches the predetermined position. In the assembly failure prevention device of the invention, however, the belt member cannot pass the predetermined position when an assembly member is not mounted on the support body, and it can hence prevent occurrences of assembly failure of allowing a belt member without the member assembled to be sent to a subsequent process.

In the assembly failure prevention device of the ninth aspect of the invention, a regulating member for forming second regulating means is provided on the passing track of the belt member. If the belt member attempts to pass the predetermined position before the assembly member reaches the predetermined position, the regulating member positioned on the passing track of the belt member is interfered with by the belt member. As a result, the belt member is restricted from passing the predetermined position.

On the other hand, when the assembly member is moved to the predetermined position, the regulating member is pressed by the assembly member, and by this pressing force, the regulating member is moved out of the passing track of the belt. In this state, if the belt member passes on the passing track, it is not interfered with by the regulating member. Hence, the belt member passes the predetermined position, and passes through the insertion hole of the assembly member.

In the assembly failure prevention device of the tenth aspect of the invention, if a support body without an assembly member mounted thereon reaches a predetermined position on the passing track of the belt member and the belt member attempts to pass the predetermined position in this state, the belt member is interfered with by second regulating means. Hence, in this state, the belt member cannot pass the predetermined position. It can hence prevent occurrences of assembly failure of allowing the belt member without the member assembled to be sent to a subsequent process.

Moreover, if a wrong member is interfered with by the interference portion of the first regulating means and dropped out of the support body, there is a high probability that only the support reaches the predetermined position. In the assembly failure prevention device of the invention, however, the belt member cannot pass the predetermined position while the assembly member is not mounted on the support body, and it can hence prevent occurrences of assembly failure of allowing the belt member without the member assembled to be sent to a subsequent process.

In the assembly failure prevention device of the eleventh aspect of the invention, a regulating member for forming second regulating means is provided on the passing track of the belt member. If the belt member attempts to pass the predetermined position before the assembly member reaches the predetermined position, the regulating member positioned on the passing track of the belt member is interfered with by the belt member. As a result, the belt member is restricted from passing the predetermined position.

On the other hand, when the assembly member is moved to the predetermined position, the regulating member is pressed by the assembly member, and by this pressing force, the regulating member is moved out of the passing track of the belt. In this state, if the belt member passes on the passing track, it is not interfered with by the regulating member. Hence, the belt member passes the predetermined position, and passes through the insertion hole of the assembly member.

In the assembly failure prevention device of the twelfth aspect of the invention, if it is attempted to move the support body to a predetermined position on the passing track of the belt member by being guided by the guide member with a wrong member not conforming to the support body mounted on the support body, the wrong member mounted on the support body is interfered with by the interference portion.

Further, when the interference portion interferes with the wrong member, the wrong member is dropped out of the support body. Therefore, the movement of the support body mounting the wrong member is restricted, and it thereby can prevent occurrences of assembly failure of allowing the belt member to pass through the insertion hole of a wrong member.

Moreover, as the wrong member is dropped out, it saves the labor of dismounting the wrong member from the support body. Therefore, if a wrong member is mounted on the support body by mistake, a decrease in work efficiency is suppressed.

In the assembly failure prevention device of the thirteenth aspect of the invention, a fitting hole is formed in the support body, and the assembly member is accommodated in this fitting hole. The fitting hole is formed corresponding to the outer shape of a specific support member, and if it is attempted to put a wrong member into the fitting hole, at least one part of the wrong member projects out from the fitting hole.

If it is attempted to move the support body to a predetermined position by being guided by the guide member with a wrong member projecting out from the fitting hole, the interference portion interferes with the part of the member projecting from the fitting hole. Further, the wrong member pressed by the interference portion is moved by the pressing force of the interference portion, and moves towards the outside of the support body, and is thereby dropped out of the support body.

It hence can prevent occurrence of assembly failure of allowing the belt member to pass through the insertion hole of a wrong member.

Moreover, as the wrong member is dropped out, it saves the labor of dismounting the wrong member from the support body. Therefore, if a wrong member is mounted on the support body by mistake, a decrease in work efficiency is suppressed.

In the assembly failure prevention device of the fourteenth aspect of the invention, if a support body without an assembly member mounted thereon reaches a predetermined position on the passing track of the belt member and the belt member attempts to pass the predetermined position in this state, the belt member is interfered with by second regulating means. Hence, in this state, the belt member cannot pass the predetermined position. It hence can prevent occurrences of assembly failure of allowing a belt member without the member assembled to be sent to a subsequent process.

Moreover, if the wrong member is interfered with by the interference portion of the first regulating means and dropped out of the support body, there is a high probability that only the support body reaches the predetermined position. In the assembly failure prevention device of the invention, however, the belt member cannot pass the predetermined position when an assembly member is not mounted on the support body, and it hence can prevent occurrences of assembly failure of allowing the belt member not assembling the member to be sent to a subsequent process.

In the assembly failure prevention device of the fifteenth aspect of the invention, a regulating member for forming second regulating means is provided on the passing track of the belt member. If the belt member attempts to pass the predetermined position before the assembly member reaches the predetermined position, the regulating member positioned on the passing track of the belt member is interfered with by the belt member. As a result, the belt member is restricted from passing the predetermined position.

On the other hand, when the assembly member is moved to the predetermined position, the regulating member is pressed by the assembly member, and by this pressing force, the regulating member is moved out of the passing track of the belt. In this state, if the belt member passes on the passing track, it is not interfered with by the regulating member. Hence, the belt member passes the predetermined position, and passes through the insertion hole of the assembly member.

In the assembly failure prevention device of the sixteenth aspect of the invention, if a support body without an assembly member mounted thereon reaches a predetermined position on the passing track of the belt member and the belt member attempts to pass the predetermined position in this state, the belt member is interfered with by second regulating means. Hence, in this state, the belt member cannot pass the predetermined position. It hence can prevent occurrences of assembly failure of allowing the belt member without the member assembled to be sent to a subsequent process.

Moreover, if the wrong member is interfered with by the interference portion of the first regulating means and dropped out of the support body, there is a high probability that only the support reaches the predetermined position. In the assembly failure prevention device of the invention, however, the belt member cannot pass the predetermined position when an assembly member is not mounted on the support body, and it hence can prevent occurrences of assembly failure of allowing the belt member not assembling the member to be sent to a subsequent process.

In the assembly failure prevention device of the seventeenth aspect of the invention, a regulating member for forming second regulating means is provided on the passing track of the belt member. If the belt member attempts to pass the predetermined position before the assembly member reaches the predetermined position, the regulating member positioned on the passing track of the belt member is interfered with by the belt member. As a result, the belt member is restricted from passing the predetermined position.

On the other hand, when the assembly member is moved to the predetermined position, the regulating member is pressed by the assembly member, and by this pressing force, the regulating member is moved out of the passing track of the belt. In this state, if the belt member passes on the passing track, it is not interfered with by the regulating member. Hence, the belt member passes the predetermined position, and passes through the insertion hole of the assembly member.

In the assembly failure prevention device of the eighteenth aspect of the invention, if a support body without an assembly member mounted thereon reaches a predetermined position on the passing track of the belt member and the belt member attempts to pass the predetermined position in this state, the belt member is interfered with by second regulating means. Hence, in this state, the belt member cannot pass the predetermined position. It hence can prevent occurrences of assembly failure of allowing the belt member not assembling the member to be sent to a subsequent process.

In the assembly failure prevention device of the nineteenth aspect of the invention, a regulating member for composing second regulating means is provided on the passing track of the belt member. If the belt member attempts to pass the predetermined position before the assembly member reaches the predetermined position, the regulating member positioned on the passing track of the belt member is interfered with by the belt member. As a result, the belt member is restricted from passing the predetermined position.

On the other hand, when the assembly member is moved to the predetermined position, the regulating member is pressed by the assembly member, and by this pressing force, the regulating member is dropped out of the passing track of the belt. In this state, if the belt member passes on the passing track, it is not interfered with by the regulating member. Hence, the belt member passes the predetermined position, and passes through the insertion hole of the assembly member.

In the assembly failure prevention device of the twentieth aspect of the invention, if a support body without an assembly member mounted thereon reaches a predetermined position on the passing track of the belt member and the belt member attempts to pass the predetermined position in this state, the belt member is interfered with by second regulating means. Hence, in this state, the belt member cannot pass the predetermined position. It hence can prevent occurrences of assembly failure of allowing a belt member without the member assembled to be sent to a subsequent process.

In the assembly failure prevention device of the twenty-first aspect of the invention, a regulating member for composing second regulating means is provided on the passing track of the belt member. If the belt member attempts to pass the predetermined position before the assembly member reaches the predetermined position, the regulating member positioned on the passing track of the belt member is interfered with by the belt member. As a result, the belt member is restricted from passing the predetermined position.

On the other hand, when the assembly member is moved to the predetermined position, the regulating member is pressed by the assembly member, and by this pressing force, the regulating member is moved out of the passing track of the belt. In this state, if the belt member passes on the passing track, it is not interfered with by the regulating member. Hence, the belt member passes the predetermined position, and passes through the insertion hole of the assembly member.

When passing the belt member into the insertion hole of the assembly member by using the assembly failure prevention device of the twenty second aspect of the invention, the assembly member is disposed at a predetermined position on the passing track of the belt member. In this state, the belt member passes on the passing track, and the belt member is inserted into the insertion hole.

Herein, if the belt member attempts to pass the predetermined position in the state before the assembly member reaches the predetermined position, the belt member is interfered with by second regulating means, and the belt member is restricted from passing the predetermined position.

It hence can prevent occurrences of assembly failure of allowing a belt member without the member assembled to be sent to a subsequent process.

In the assembly failure prevention device of the twenty second aspect of the invention, a regulating member for composing regulating means is provided on passing track of belt member. If the belt member attempts to pass the predetermined position before the assembly member reaches the predetermined position, the regulating member positioned on the passing track of the belt member is interfered with by the belt member. As a result, the belt member is restricted from passing the predetermined position.

On the other hand, when the assembly member is moved to the predetermined position, the regulating member is pressed by the assembly member, and by this pressing force, the regulating member is moved out of the passing track of the belt. In this state, if the belt member passes on the passing track, it is not interfered with by the regulating member. Hence, the belt member passes the predetermined position, and passes through the insertion hole of the assembly member.

As described herein, the assembly failure prevention device of the invention effectively can prevent occurrences of assembly failure of members with the belt member.

### BRIEF DESCRIPTION OF THE DRAWINGS

FIG. 1 is an outline diagram of a system of an assembly failure prevention device in an embodiment of the present invention.

FIG. 2 is a perspective view showing relevant parts of an assembly failure prevention device in an embodiment of the invention.

FIG. 3 is a perspective view corresponding to FIG. 2 showing a state of an assembly member installed in a fitting hole of a support body.

FIG. 4 is a side view showing a state of an assembly member corresponding to a mounting hole of a support body being installed in a fitting hole of the support body.

FIG. 5 is a side view corresponding to FIG. 4 showing a state in which a wrong assembly member is installed in a fitting hole of a support body.

FIG. 6 is a front view showing relevant parts of an assembly failure prevention device in an embodiment of the invention.

FIG. 7 is a front view corresponding to FIG. 6 showing a state of a support body, having an assembly member corresponding to a fitting hole of the support body installed in the fitting hole, reaching a predetermined position.

### BEST MODE FOR CARRYING OUT THE INVENTION

### Configuration of an Embodiment

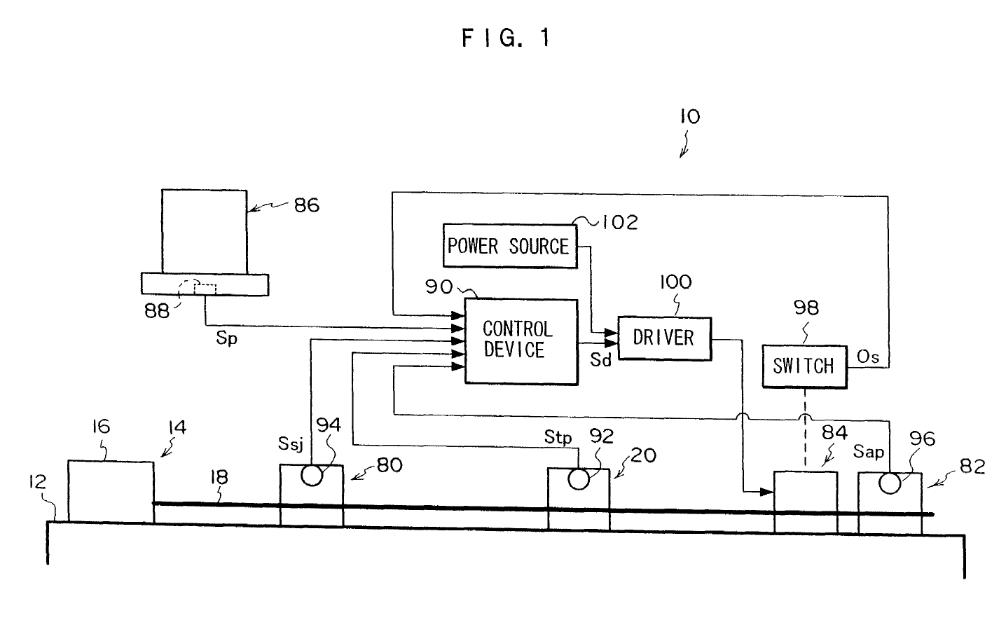

FIG. 1 schematically shows the overall configuration of an assembly failure prevention device 10 in an embodiment of the present invention.

As shown in FIG. 1, the assembly failure prevention device 10 has a base 12. A retractor 16 composing a seat belt device 14 is disposed at one end of the base 12 (left side in the lateral direction in FIG. 1).

In a spool of the retractor 16, a longitudinal end of a webbing belt 18 of a long band shape as a belt member is engaged. A proper amount of webbing belt 18 is pulled out from the spool toward the other side on the base 12 (right side in the lateral direction in FIG. 1).

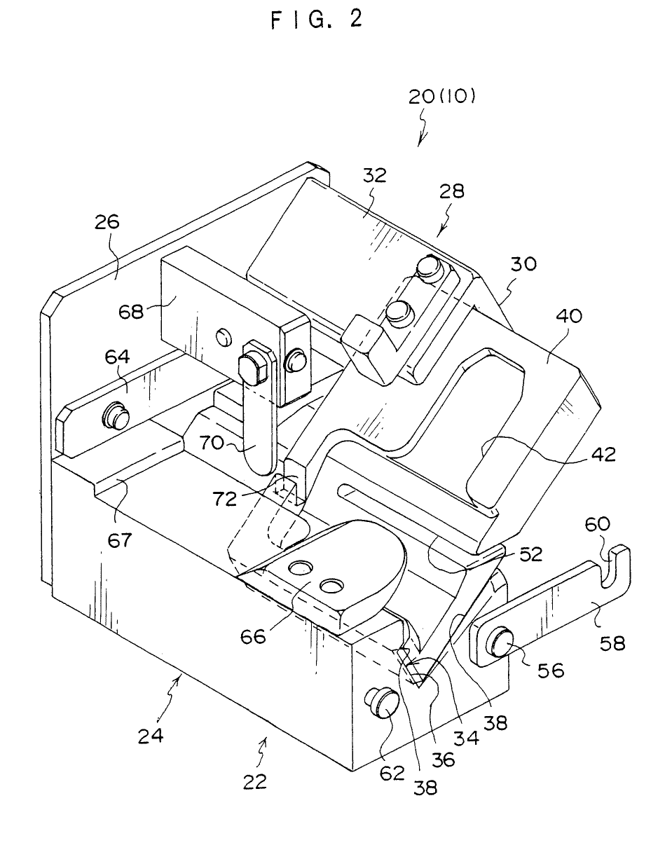

On the base 12, a tongue support device 20 is mounted as wrong member assembly preventive means. In FIG. 2, a perspective view of tongue support device 20 is shown. As shown in the diagram, the tongue support member 20 has a device main body 22.

The device main body 22 has a slide base 24. The slide base 24 is formed like a substantially rectangular shape. The slide base 24 is disposed on the base 12 with its width direction along the direction from one end to other end of the base 12. A side plate 26 is provided at the longitudinal end of slide base 24.

The side plate 26 is fixed on the slide base 24, and the upper end portion of side plate 26 projects upward from the top face of the slide base 24. Above the slide base 24, guide means is formed, and a guide rail 28 for structuring first regulating means is provided as an interference portion.

The guide rail 28 has a bottom wall 30. The bottom wall 30 is formed like a plate with the long side along the longitudinal direction of the slide base 24. The width direction of bottom wall 30 is inclined relative to the thickness direction of slide base 24 and the width direction of slide base 24. A pair of guide walls 32 is provided at both ends in the width direction of the bottom wall 30.

The pair of guide walls 32 is extended in the orthogonal direction from the bottom wall 30. Accordingly, the guide rail 28 is formed in a concave shape opened in a direction inclined downward and to one side in the width direction of slide base 24. The longitudinal dimension of the guide rail 28 is shorter than the longitudinal direction of the slide base 24.

The guide rail 28 has one longitudinal end tightened and fixed to the side plate 26 above the slide base 24. Corresponding to the guide rail 28, a guide groove 34 is formed in the slide base 24 for forming guide means together with the guide rail 28.

The guide groove 34 is formed on an extension of the open direction of guide rail 28 (one side in the thickness direction of the bottom wall 30). The guide groove 34 is open at an upper side of the slide base 24. The bottom 36 of the guide groove 34 is a sloped surface inclined in the same direction as the other side in the thickness direction of the bottom wall 30 of the guide rail 28 (back side), and the bottom 36 opposes the bottom 30 of the guide rail 28.

Inner walls 38 are formed attached from both sides in the width direction of the bottom 36 of the guide groove 34 and are directed in the orthogonal direction to the bottom 36, and the spacing of one inner wall 38 and other inner wall 38 is substantially the same as the spacing of the pair of guide walls 32. The guide groove 34 is also open at both ends in the longitudinal direction of slide base 24, and further the guide rail 28 is also open at both ends in the longitudinal direction.

A slide plate 40 is inserted as a support body inside of the guide groove 34 and inside of the guide rail 28. The slide plate 40 is formed in a flat rectangular shape in plan view. The dimension across the slide plate 40 is slightly shorter than the distance from the bottom 36 of the guide groove 34 to the bottom wall 30 of the guide rail 28.

Thickness dimension of slide plate 40 is set slightly smaller than the spacing of the pair of guide walls 32 of guide rail 28 and the spacing of the inner walls 28 of guide groove 34. Accordingly, the slide plate 40 is guided by the guide rail 28 and guide grooves 34 in a state of having one longitudinal end disposed between the guide rail 28 and the other longitudinal end disposed between guide grooves 34, and is constructed to slide in the longitudinal direction of slide base 24.

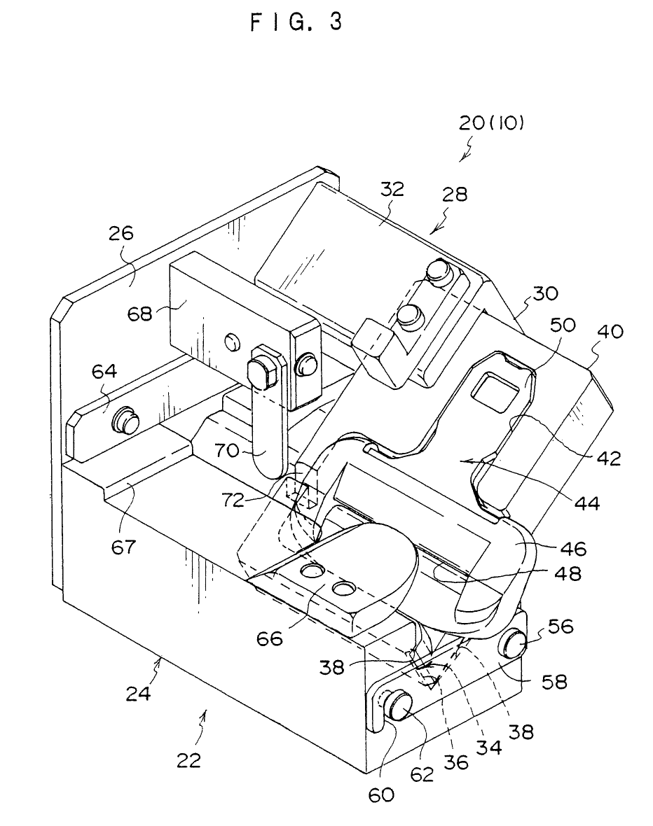

A fitting hole 42 is formed in one side in the thickness direction of slide plate 40, and as shown in FIG. 3, a tongue plate 44, as an assembly member in the seat belt device 14 to be gripped by a belt support member, is fitted into the fitting hole 42.

In this embodiment, as shown in FIG. 2, in a state of fitting the slide plate 40 into the guide groove 34 at the other longitudinal end of slide base 24 (the opposite end to side plate 26), the dimensions of slide base 24, guide rail 28, and slide plate 40, and the position of forming fitting hole 42 in slide plate 40 are determined so that the slide plate 40 may be seated within the guide rail 28 at the side of the slide plate 40 closer to the side plate 26 than the fitting hole 42.

Accordingly, if the slide plate 40 slides to a position where the fitting hole 42 is not opposite to a guide wall 32 of the guide rail 28, the slide plate 40 remains fitted into both guide rail 28 and guide groove 34. Hence, the tongue plate 44 can be fitted into the fitting hole without detaching the slide plate 40 from the guide rail 28 and guide groove 34.

The tongue plate 44 fitted into the fitting hole 42 has a base 46. The base 46 is formed in a longitudinal direction along the whole width direction of slide plate 40. A slit-shaped insertion hole 48 is formed in the base 46 to allow the webbing belt 18 to pass through.

Further, from substantially the center in the longitudinal direction of base 46, extends an insertion portion 50, to be fitted in a buckle device, not shown. Several types of tongue plate 44 are prepared depending on car models, and each type differs in outer peripheral shape, thickness, and inclination angle of insertion portion 50 relative to base 46.

As shown in FIG. 2, moreover, a slit 52 is formed in the bottom of the fitting hole 42. The slit 52 is open at the bottom of fitting hole 42 and at the opposite side of the slide plate 40 to the forming of the fitting hole 42.

While the tongue plate 44 is installed in the fitting hole 42, the insertion hole 48 formed in the base 46 of the tongue plate 44 and the slit 52 are opposite to each other, and the webbing belt 18 passing through the insertion hole 48 can pass through the slit 52.

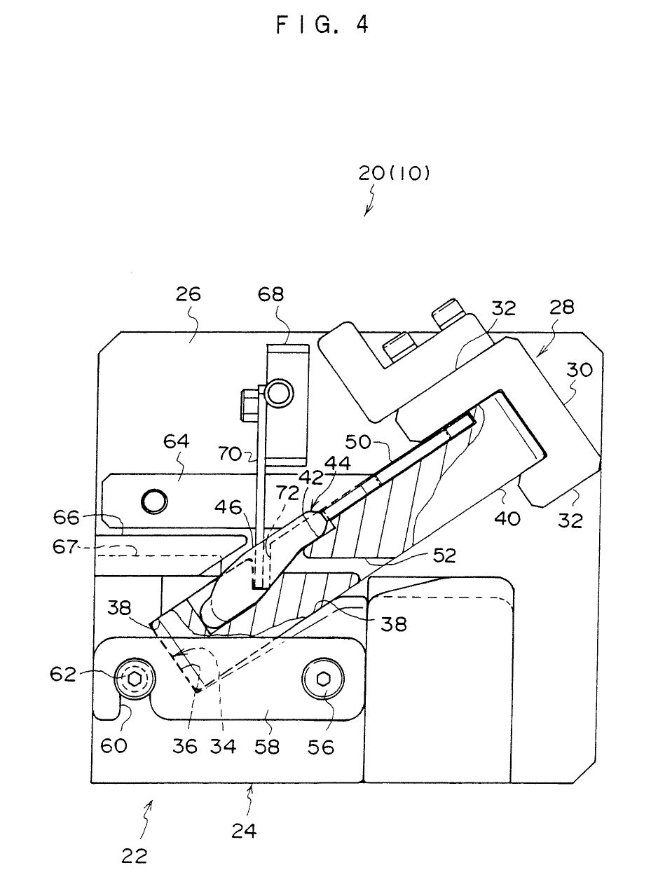

Further, as shown in FIG. 4, the slit 52 penetrates through the slide plate 40 in a state inclined relative to the thickness direction of slide plate 40. The angle of inclination of the penetration direction of slit 52 relative to the thickness direction of slide plate 40 is, for example, equivalent to an angle derived by subtracting the inclination angle of the opening direction (direction of bottom 36) of guide groove 34 relative to the top face of slide base 24 from 90 degrees. Accordingly, while the slide plate 40 is fitted into the guide groove 34, the penetration angle of the slit 52 is substantially parallel to the top surface of slide base 24.

As shown in FIG. 2, the slit 52 is open to the other end in the width direction of slide plate 40, and with the webbing belt 18 passing through both insertion hole 48 and slit 52, the tongue plate 44 fitted in the fitting hole 42 is moved to the other side in the width direction of slide plate 40, and the tongue plate 44 is taken out of the slide plate 40, and the webbing belt 18 passes out of the slit 52.

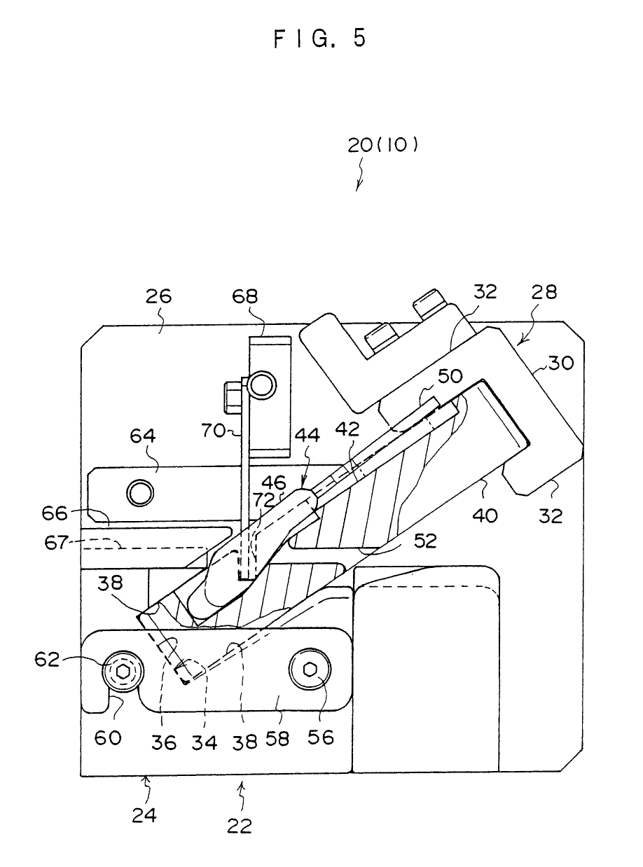

The fitting hole 42 allows the fitting of only one (specific) tongue plate 44 from the plural tongue plates 44, and if it is attempted to fit a wrong tongue plate 44 into the fitting hole 42, the outer peripheral shape of the tongue plate 44 and the inner peripheral shape of the fitting hole 42 are not matched, the tongue plate 44 cannot be inserted into the fitting hole 42, or if the base 46 of a wrong tongue plate 44 is disposed inside of the fitting hole 42, as shown in FIG. 5, the insertion portion 50 of the tongue plate 44 projects outside the fitting hole 42.

As is shown in FIG. 2, in the fitting hole 42 there is a gap at the inner periphery at one end side in width direction of slide plate 40. The gap portion of the inner periphery corresponds to the base 46 of the tongue plate 44, and in the state where the tongue plate 44 is fitted in the fitting hole 42, part of the base 46 projects outside from one end in the width direction of slide plate 40.

Therefore, for example, with a wrong tongue plate 44 fitted in the fitting hole 42, if the insertion portion 50 of the tongue plate 44 projects outside of the fitting hole 42, the wrong tongue plate 44 is not interfered with to any great amount by the inner periphery of the fitting hole 42, and so can slide to one side in the width direction of slide plate 40, and slip out of the slide plate 40.

On the other hand, as shown in FIG. 2, a shaft 56 is installed at the other longitudinal end of slide base 24. The base end of stopper 58 is rotatably supported on the shaft 56. The stopper is a substantially rectangular plate member in plan view. At the leading end in the longitudinal direction of the stopper 58, a notch 60 is formed, open at one end in the width direction.

Corresponding to the notch 60, a support shaft 62 is provided at one longitudinal end of slide base 24. When the stopper 58 is rotated in one direction around the shaft 56, as shown in FIG. 2, the support shaft 62 locates into the notch 60. In this state, the stopper 58 is supported by the support shaft 62, and further rotation of stopper 58 around the shaft 56 is restricted.

While the rotation of stopper 58 is restricted, the stopper 58 covers part of the opening end of guide groove 34 at other longitudinal end of slide base 24. In this state, if the slide plate 40 is disposed between the guide groove 34 and guide rail 28, the slide plate 40 cannot slip out of the other longitudinal end of slide base 24.

Further, as shown in FIG. 2, an end point positioning piece 64 is provided in the side plate 26. The end point positioning piece 64 is fixed to the side plate 26 parallel to the top face of slide base 24 and above the top face of slide base 24. As being guided by the guide rail 28 and guide groove 34, the slide plate 40 slides to the one longitudinal end of slide base 24, and when the slide plate 40 reaches the point at the end of the movement, the end point positioning piece 64 abuts against (interferes with) the slide plate 40.

Moreover, as shown in FIG. 2, at the one longitudinal end of slide base 24, a guide wall 67 is formed at the top face of slide base 24. The guide wall 67 is formed like a block facing toward one longitudinal side of slide base 24.

Corresponding to the guide wall 67, a tongue-shaped belt guide 66 is provided on the to face of slide base 24. The belt guide 66 is provided at the other longitudinal side of slide base 24 from the guide wall 67. The spacing between the belt guide 66 and guide wall 67 is slightly larger than the width dimension of webbing belt 18, as a belt member inserted into insertion hole 48 formed in the tongue plate 44.

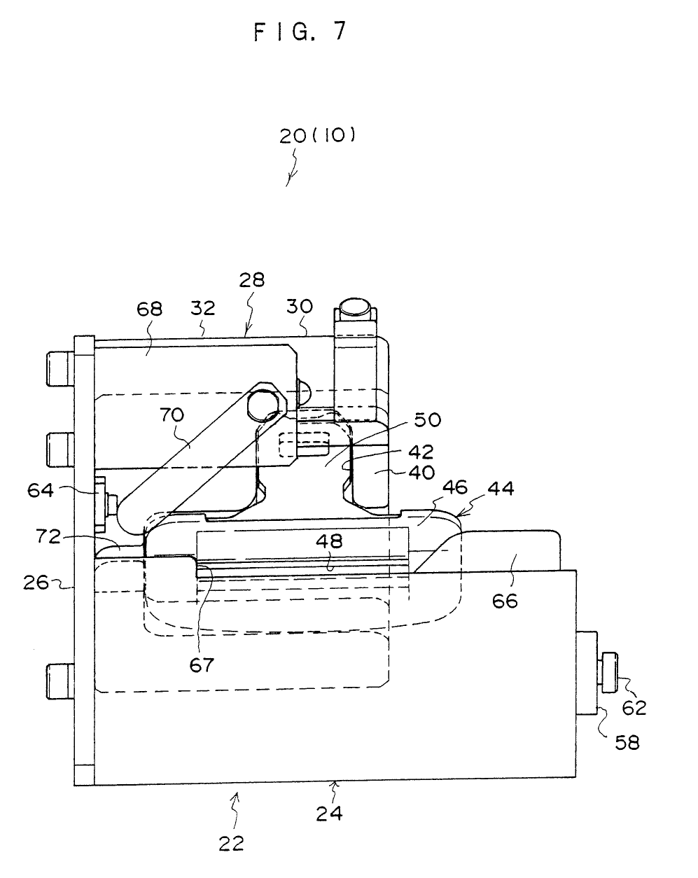

As shown in FIG. 7, in the state in which the slide plate 40 slides until it a butts against the end point positioning piece 64, being guided by the guide groove 34 and guide rail 28, one longitudinal end of insertion hole 48 of tongue plate 44 fitted in the fitting hole 42 is positioned at a line extended along the face of the guide wall 67 on the belt guide 66 side, while the other longitudinal end of insertion hole 48 is positioned on a line extended along the side face of the belt guide 66 on the guide wall 67 side.

Therefore, the webbing belt 18 is disposed between the belt guide 66 and guide wall 67, the webbing belt 18 is guided by the belt guide 66 and guide wall 67, and moved to the side of tongue plate 44, so that the webbing belt 18 passes through the insertion hole 48.

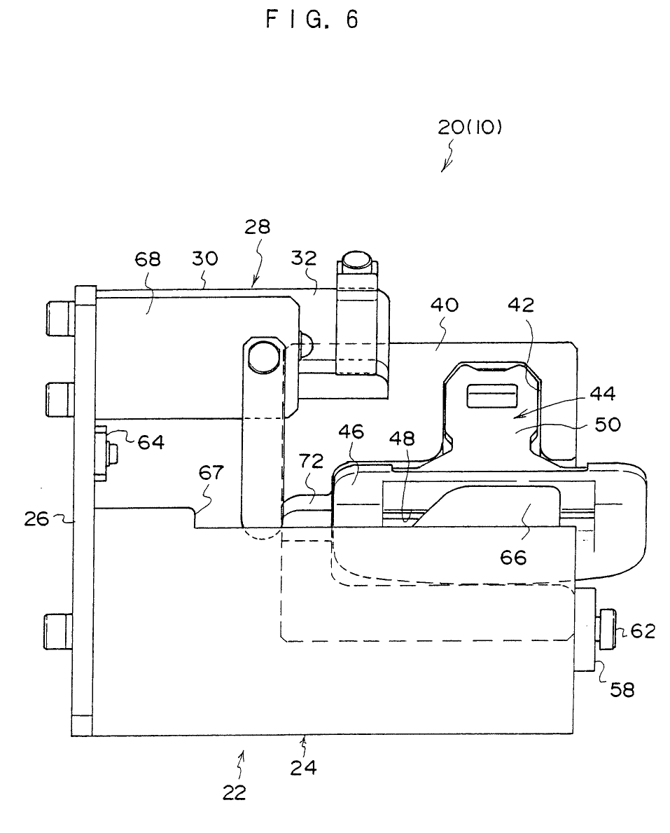

Or, as shown in FIG. 6, while the tongue plate 44 fitted in the fitting hole 42 of the slide plate 40 and the belt guide 66 are opposite to each other along the width direction of slide base 24, the belt guide 66 is positioned on a line extended from the fitting hole 48 along the width direction of slide base 24.

Thus, if it is attempted to insert the webbing belt 18 into the insertion hole 48 while the belt guide 66 is positioned on a line extended from the insertion hole 48, the webbing belt 18 is interfered with by the belt guide 66, and the webbing belt 18 cannot pass through the insertion hole 48.

That is, the belt guide 66 functions as guide means for guiding the webbing belt 18 when the webbing belt 18 passes between it and guide wall 67, but when the tongue plate 44 and belt guide 66 are opposite to each other in the width direction of slide base 24, it functions as insertion regulating means for preventing insertion of the webbing belt 18 into the insertion hole 48 as described above.

On the other hand, as shown in FIG. 2, a support piece 68 of block shape or plate shape is provided at a side of guide rail 28 along the width direction of slide base 24. The support piece 68 is fixed to the side plate 26. The support piece 68 has an oscillating piece 70 forming second regulating means as a regulating member.

The oscillating piece 70 is a plate member with a thickness direction along the width direction of slide plate 24. The oscillating piece 70 is fitted to the support piece 68 by way of a shaft member penetrating in the thickness direction at the base end in the longitudinal direction, and the oscillating piece 70 is free to oscillate about the penetrating position of the shaft member.

Corresponding to the leading end of oscillating piece 70, a slit 72 is formed in the slide plate 40. The slit 72 is formed at one side in the width direction (the side of the slide plate 26) of the fitting hole 42. The slit 72 is open at one side in the width direction of slide plate 40, and is also open at the outer side of slide plate 40 and inner side of fitting hole 42.

The inner width dimension of slit 72 is larger than the thickness dimension of the oscillating piece 70, and when the slide plate 40 slides to the side of side plate 26 being guided by guide rail 28 and guide groove 34, the leading end of oscillating piece 70 locates into the inside of slit 72. If, in the state of no tongue plate 44 being fitted in the fitting hole 42, the slide plate 40 moves until it is abutting against the end point positioning piece 64, the oscillating piece 70 passes through the slit 72, and the leading end of oscillating piece 70 locates into the inside of fitting hole 42 and opposes the slit 52 in the middle part in longitudinal direction of the slit 52.

On the other hand, as shown in FIG. 1, in the state of the retractor 16 disposed at one end of the base 12, a slip joint support device 80 is disposed as wrong member assembly preventive means between the tongue support device 20 and retractor 16 on the base 12. This slip joint support device 80 is basically the same in structure as the tongue support device 20, What differs between the slip joint support device 80 and the tongue support device 20 is that the slide plate 40 of the tongue support device 20 has a fitting hole 42 conforming to the shape of the tongue plate 44.

By contrast, the slide plate 40 of the slip joint support device 80 has a fitting hole 42 conforming to the shape of a slip joint (not shown), to be gripped as a belt support assembly member to be assembled together with the tongue plate 44 in the seat belt device 14.

An anchor support device 82 is disposed as wrong member assembly preventive means at the opposite side of slip joint support device 80 on the other side of tongue support device 20 on the base 12, and it is also basically the same in structure as the tongue support device 20.

What differs between anchor support device 82 and tongue support device 20 is that the slide plate 40 of anchor support device 82 has a fitting hole 42 conforming to the shape of an anchor plate (not shown), to be gripped as a belt support assembly member to be assembled together with the tongue plate 44 in the seat belt device 14.

Further, a sewing machine 84 is provided between the tongue support device 20 and anchor support device 82 as suturing means. The sewing machine is provided near the anchor support device 82, and when the webbing belt 18 passes through the insertion hole formed in the anchor plate and is folded back on itself, the folded portion of the webbing belt 18 is sutured integrally with a portion of the webbing belt 18 on the main side of the insertion hole.

As shown in FIG. 1, the assembly failure prevention device 10 has a job instruction device 86. The job instruction device 86 is composed of a point table of flat plate shape, and a holder for displaying the point table (neither shown).

The indication surface of the point table shows characters and design information (part numbers and description of members to be used) to be used in the assembly for the seat belt device 14 among plural types of seat belt device 14. By displaying the point table by the holder, the type of seat belt device 14 for assembly work, and part numbers of members used in assembly work can be confirmed.

The holder for displaying the point table has a switch 88, and when the point table is displayed on the holder, the instruction signal Sp issued from the switch 88 is changed from low level to high level. The switch 88 is connected to a control device 90, and the instruction signal issued from the switch 88 is inputted into the control device 90.

The control device 90 is electrically connected to a magnetic sensor 92 as a tongue detecting unit, which is a mode of a support body detecting unit provided in the tongue support device 20. The magnetic sensor 92 is provided, for example, at the above-described side plate 26.

The magnetic sensor 92 is composed of a magnetoresistive element and a permanent magnet, and when the tongue plate 44 fitted to the slide plate 40 is guided by the guide rail 22 and guide groove 34 and approaches the side plate 26, the magnetism of the permanent magnet of magnetic sensor 92 is attracted to the metal (magnetic material) portion of tongue plate 44, and thereby the direction of magnetism passing through the magnetoresistive element is changed.

Thus, when the tongue plate 44 approaches the magnetic sensor 92, tongue detection signal Stp issued from the magnetic sensor 92 is changed from low level to high level.

Also as shown in FIG, 1, the slip joint support device 80 has a magnetic sensor 94 as an slip joint detecting unit as a mode of support body detecting unit, and the anchor support device 82 has a magnetic sensor 96 as an anchor detecting unit as a mode of support body detecting unit.

These magnetic sensors 94, 96 are basically the same in structure as the magnetic sensor 92, and when the slip joint or anchor plate approaches the magnetic sensor 94 or magnetic sensor 96, slip joint detection signal Ssj or anchor detection signal Sap issued from the magnetic sensor 94 or magnetic sensor 96 is changed from low level to high level.

Further, the control device 90 is electrically connected to a switch 98 of sewing machine 84, and an operation signal Os issued from the switch 98 is inputted into the control device 90. When the switch is manipulated in order to operate the sewing machine 84, the operation signal Os issued from the switch 98 is changed from low level to high level.

On the other hand, the control device 90 is electrically connected to a driver 100, and a control signal Sd issued from the control device 90 is inputted into the driver 100. Thus, the control signal 90 receives signals Sp, Stp, Ssj, Sap, and Os, and when all these signals Sp, Stp, Ssj, Sap, and Os become high level, control signal Sd is changed from low level to high level.

The driver 100 connected to the control device 90 is electrically connected to a power source 102 and a motor of sewing machine 84, and once control signal Sd of high level is inputted into the driver 100, the driver 100 the motor of the sewing machine 84 to conduction mode, and starts operation of sewing machine 84.

### Operation and Effect of the Embodiment

The operation and effect of the embodiment are described through explanation of operation of the assembly failure prevention device 10.

When assembling the slip joint, tongue plate 44 and anchor plate in the webbing belt 18 by using the assembling failure prevention device 10, first, the point table is pulled up on the holder of the job instruction device 86. The worker checks the point table set up on the holder of the job instruction device 86, and selects the slide plates 40 that conform to the slip joint, tongue plate 44 and anchor plate used in the assembly work.

For example, in the tongue support device 20, the slide plate 40 selected on the basis of the design and characters displayed on the surface of the point table is inserted between the guide groove 34 and guide rail 28. In this state, as shown in FIG. 2, the slide plate 40 slides to the position opposite to the belt guide 66 along the width direction of slide base 24.

Next, as shown in FIG. 3 and FIG. 6, in this state, the tongue plate 44 is inserted into the fitting hole 42 of the slide plate 40. Further, with the tongue plate 44 being inserted in the fitting hole 42, as shown in FIG. 6, the slide plate 40 slides to the side of the side plate 26 until the slide plate 40 abuts against the end point positioning piece 64. Thus, when the slide plate 40 slides to the side of the side plate 26, the leading end of the oscillating piece 70 slots into the slit 72.

However, the tongue plate 44 has been already fitted inside the fitting hole 42. Hence, as the slide plate 40 slides, the leading end of the oscillating piece 70 slotting into the slit 72 abuts against the tongue plate 44, and is pressed and oscillated by the tongue plate 44, and is removed from the passing track (disposing track) of the webbing belt 18.

At about the time of sliding of slide plates 40 to the side of the side plates 26 in the tongue support device 20, slip joint support device 80, and anchor support device 82, the retractor 16 is placed at one end of the base 12.

The spool of the retractor 16 has been already engaged at the longitudinal end side of the webbing belt 18. In this state, the leading end of the webbing belt 18 is inserted into the insertion hole of the slip joint installed in the slide plate 40 of the slip joint support device 80.

Consequently, the leading end of the webbing belt 18 is inserted into the insertion hole of the tongue plate 44 installed in the slide plate 40 of the tongue support device 20. Further, the leading end of the webbing belt 18 is inserted into the insertion hole of the anchor plate installed in the slide plate 40 of the anchor support device 82.

Herein, as mentioned above, while the slide plate 40 is fitted in the guide groove 34, the penetration direction of the slit 52 is substantially parallel to the upside of the slide base 24. Hence, the webbing belt 18 can be easily passed through the slit 52, and the job efficiency is extremely high.

The webbing belt 18 passing through the insertion hole of anchor plate is folded back, and overlaid on the webbing belt 18 at the base end side of the insertion hole of the anchor plate. In this state, the switch 98 of the sewing machine 84 is manipulated. By manipulation of switch 98, the work signal Os issued from the switch 98 is changed from low level to high level.

Further in this state, since the point table is set up on the holder of the job instruction device 86, the instruction signal Sp issued from the switch 88 is changed from low level to high level.

In this state, the slip joint, tongue plate 44, and anchor plate are respectively fitted in the slides plates 40 of tongue support device 20, slip joint support device 80, and anchor support device 82, and each support plate 40 slides to the side of the side plate 26.

Therefore, in this state, the signals Stp, Ssj, and Sap are issued from the magnetic sensors 92 of tongue support devices 20, magnetic sensor 94 of slip joint support device 80, and magnetic sensor 96 of anchor support device 82 are changed from low level to high level.

That is, in this state, since signals Stp, Ssj, Sap, Sp, and Os entering the control device 90 are all in high level, control signal Sd issued from the control device 90 is changed from low level to high level. As a result, when the control signal Sd of high level is inputted into the driver 100, a driving current flows in the motor of the sewing machine 84, and the sewing machine 84 is put into operation.

When the sewing machine 84 is thus started, the webbing belt 18 is sutured in the overlaid state near the insertion hole of slide plate 40, and assembling of slip joint, tongue plate 44, and anchor plate into the webbing belt 18 is completed.

Incidentally, there is a possibility that a tongue plate 44 not conforming to the inner peripheral shape of fitting hole 42 of slide plate 40, that is, a wrong tongue plate 44, is fitted into the slide plate 40 in the tongue support device 20.

In the tongue support device 20 of the assembly failure prevention device 10, in the state where a wrong tongue plate 44 is fitted into the slide plate 40, even if the base 46 of wrong tongue plate 44 is fitted into the fitting hole 42, the insertion portion 50 projects from the fitting hole 42 as shown in FIG. 5. Hence, when the slide plate 40 mounted with a wrong tongue plate 44 slides to the side of the side plate 26, the insertion portion 50 projecting from the fitting hole 42 interferes with the other longitudinal end of the guide rail 28.

Therefore, if a wrong tongue plate 44 is mounted on the slide plate 40, basically, the slide plate 40 cannot slide to the side of the side plate 26.

In this state, if it is attempted to move the slide plate 40 by pressing the slide plate 40 toward the side plate 26, the pressing reaction force from the other longitudinal end side of the guide rail 28 presses the insertion portion 50 of tongue plate 44 projecting from the fitting hole 42 to the opposite side of the side plate 26.

As described above, when the insertion portion 50 of tongue plate 44 projects outside of the fitting hole 42, the wrong tongue plate 44 is not interfered to any great extent by the inner peripheral edge of the fitting hole 42. Hence the wrong tongue plate 44 receives the pressing reaction force at its insertion portion 50 from other longitudinal end of guide rail 28, and moves relatively in the opposite direction to the sliding direction of slide plate 40, and drops out at one end in the width direction of the slide plate 40.

As a result, the wrong tongue plate 44 will not reach the passing position of the webbing belt 18, and the webbing belt 18 is not passed into the insertion hole 48 of the wrong tongue plate 44 (that is, assembly error does not occur).

After the wrong tongue plate 44 is dropped out of the slide plate 40, the slide plate 40 may slide toward the side plate 26 until abutting against the end point positioning piece 64. Or, in a state without having a tongue plate 44 fitted in the fitting hole 42 from the beginning, the slide plate 40 may slide toward the side plate 26 until abutting against the end point positioning piece 64.

In such a state not having a tongue plate 44 fitted in the fitting hole 42, if the slide plate 40 moves toward the side plate 26, the oscillating piece 70 placed in the slit 72 will not abut against the tongue plate 44. Accordingly, the leading end of oscillating piece 70 passes through the slit 72 without rotation, and the leading end of oscillating piece 70 slots into the fitting hole 42, and opposes the slit 52 formed in the bottom of the fitting hole 42.

In this state, if it is attempted to pass the webbing belt 18 in the slit 52, the webbing belt 18 is interfered with by the oscillating piece 70, and cannot pass through the slit 52. Therefore, if the slide plate 40 is slid toward the side plate 26 until abutting against the end point positioning piece 64 without fitting tongue plate 44 in the fitting hole 42, the webbing belt 18 cannot be passed through the slit 52. Failure to assemble tongue plate 44 onto webbing belt 18 does not occur (that is failure of missing out a part does not occur).

Thus, if the slide plate 40 is slid toward the side plate 26 until abutting against the end point positioning piece 64 without fitting tongue plate 44 in the fitting hole 42, the magnetism of the permanent magnet of magnetic sensor 92 does not come under the influence of metal parts of tongue plate 44. In this state, therefore, the tongue detection signal Stp issued from magnetic sensor 92 is not changed from low level to high level.

Accordingly, if the switch 98 of the sewing machine 84 is manipulated, the driver 100 does not pass a driving current through the motor of sewing machine 84, and a suturing operation is not started.

By using the tongue support device 20, it is effective to prevent occurrence of defective assemblies, such as passing of webbing belt 18 into insertion hole 48 of wrong tongue plate 44, or failure to assemble tongue plate 44 onto webbing belt 18.

Other instances may be imagined, that is such as, not fitting the tongue plate 44 into fitting hole 42 of slide plate 40, attempting to pass the webbing belt 18 into the insertion hole 48 of tongue plate 44, after disposing the webbing belt 18 at a different position from the specified passing position (disposing position) of webbing belt 18, such as above the support piece 68 or outside of side plate 26 (opposite side of slide base 24 of side plate 26). In such events of operation different from the specified operation, the wrong tongue plate 44 cannot be dropped out of the slide plate 40 as mentioned above.

In this case, however, since tongue plate 44 is not fitted into the fitting hole 42 of slide plate 40, tongue detection signal Stp issued from magnetic sensor 92 is not changed from low level to high level. Therefore, in such event, the motor of the sewing machine 84 is not driven, and a suturing operation is not started.

Thus, wrong operation different from the specified operation is prevented, and assembling of a wrong tongue plate 44 or failure to assemble the tongue plate due to wrong operation can be effectively prevented.

Similarly, the slip joint support device 80 and anchor support device 82 also have the same effects and actions as the tongue support device 20 as explained above.

In the assembly failure prevention device 10 of the embodiment, therefore, wrong assembly or failure to assemble tongue plate 44, a slip joint, or an anchor plate can be effectively prevented.

In the embodiment, magnetic sensors 92 to 96 are applied as support body detecting units such as tongue detecting unit, slip joint detecting unit, and anchor detecting unit, but support body detecting units in wrong member assembly preventive means are not limited to magnetic sensors 92 to 96 alone. For example, as long as it is detected directly or indirectly that the slide plate 40 mounting tongue plate 44 has reached the disposing position (passing position) of webbing belt 18, the support body detecting unit is not particularly limited.

Although not applied in the embodiment, for example, the control device 90 may be designed so as not to change over the control signal Sd from low level to high level unless the slide plate 40 conforming to the tongue plate 44, slip joint, and anchor plate indicated on the point table set up on the holder of the job instruction device 86 is fitted into the guide groove 34 of each slide base 24 of the tongue support device 20, slip joint support device 80, and anchor support device 82.

As an example of such a configuration, plural fixed contacts are provided in the bottom 36 of the guide groove 34, and sliding contact(s), which conduct(s) by sliding and contacting with some of the plural fixed contact points in the bottom 36, provided on the end of the slide plate 40 opposing the bottom 36. Depending on the type of tongue plate 44, the pattern formed of sliding contacts of the slide plate 40 is changed, and the control device 90 detects the fixed contacts slidably contacting with the sliding contact point(s). Also, the plural fixed contacts of the bottom 36 are set up in the holder supporting the point table, and each point table has a movable contact point which conducts by moving and contacting with some of the plural fixed contact points of the holder when setting up the point table. The pattern of movable contact points of the point table is also varied depending on the type of tongue plate 44, and the control device 90 detects the fixed contact points of the holder contacting with the movable contact point.

The control device 90 compares the fixed contact point(s) of the bottom 36 conducting with the sliding contact point and the fixed contact point(s) of the holder conducting with the movable contact point, determines if the selected slide plate 44 conforms to the presented point table or not, operates warning means, such as an alarm lamp or alarm sound provided separately, if the selected slide plate 40 does not conform to the presented point table, thereby informing the worker that the selected slide plate 40 does not conform to the presented point table, or controls the driver for operating the sewing machine to maintain a power turn-off state of the sewing machine 84 if the operation signal Os from the switch 98 is changed from low level to high level. In such a configuration, assembly of a wrong tongue plate 44 due to selection error of slide plate 40 can be effectively prevented.

### DESCRIPTION OF REFERENCE NUMERALS

10 Assembly failure prevention device
18 Webbing belt (belt member)
28 Guide rail (guide means, first regulating means, interference portion)
34 Guide groove (guide means)
40 Slide plate (support body)
42 Fitting hole
44 Tongue plate (assembly member)
48 Insertion hole
70 Oscillating piece (regulating member, second regulating means)

1. An assembly failure prevention device used in an assembling process of assembling an assembly member onto a belt member by inserting the belt member into the assembly members having insertion holes for inserting the belt member, comprising:
a support body for supporting a specific assembly member, of plural types of the assembly members having outer shapes different from each other, in a state allowing the belt member to pass through the insertion hole,
guide means for guiding the support body to a predetermined position that is the position on the passing track of the belt member at the time of passing the belt member into the insertion hole, and
first regulating means for preventing the support body to move to the insertion position when a wrong assembly member different from the specific member has been mounted on the support body.

2. The assembly failure prevention device according to claim 1, wherein the first regulating means includes an interference portion for interfering with a part of the wrong assembly member when the support body is guided by the guide means and moved to the predetermined position side, such that the support body is prevented from moving to the predetermined position side by the interference of the interference portion with a part of the wrong assembly member.

3. The assembly failure prevention device according to claim 2, wherein the support body includes a fitting hole capable of accommodating the specific assembly member inside thereof and projecting outside at least one part of the wrong assembly member when the wrong assembly member is accommodated therein, such that the interference portion interferes with the part of the wrong assembly member projecting from the fitting hole.

4. The assembly failure prevention device according to claim 3, wherein the interference portion interferes with the wrong assembly member mounted on the support body, and drops the wrong assembly member from the support body.

5. The assembly failure prevention device according to claim 4, wherein the support body includes a fitting hole capable of accommodating the specific assembly member inside thereof, projecting outside at least one part of the wrong assembly member when the wrong assembly member is accommodated therein and moving the wrong assembly member in an interference direction of the interference portion with the wrong assembly member.

6. The assembly failure prevention device according to claim 5, further comprising second regulating means provided on the passing track of the belt member, for interfering with the belt member which is about to pass through the predetermined position when the support body supporting the assembly member has not yet reached the predetermined position, such that the belt member is prevented from passing through the predetermined position.

7. The assembly failure prevention device according to claim 6, wherein the second regulating means includes a regulating member provided on the passing track of the belt member, the regulating member being moved out of the passing track by being pressed by the assembly member moving to the predetermined position.

8. The assembly failure prevention device according to claim 4, further comprising second regulating means provided on the passing track of the belt member, for interfering with the belt member which is about to pass through the predetermined position when the support body supporting the assembly member has not yet reached the predetermined position, such that the belt member is prevented from passing through the predetermined position.

9. The assembly failure prevention device according to claim 8, wherein the second regulating means includes a regulating member provided on the passing track of the belt member, the regulating member being moved out of the passing track by being pressed by the assembly member moving to the predetermined position.

10. The assembly failure prevention device according to claim 3, further comprising second regulating means provided on the passing track of the belt member, for interfering with the belt member which is about to pass through the predetermined position when the support body supporting the assembly member has not yet reached the predetermined position, such that the belt member is prevented from passing through the predetermined position.

11. The assembly failure prevention device according to claim 10, wherein the second regulating means includes a regulating member provided on the passing track of the belt member, the regulating member being moved out of the passing track by being pressed by the assembly member moving to the predetermined position.

12. The assembly failure prevention device according to claim 2, wherein the interference portion interferes with the wrong assembly member mounted on the support body, and drops the wrong assembly member from the support body.

13. The assembly failure prevention device according to claim 12, wherein the support body includes a fitting hole capable of accommodating the specific member inside thereof, projecting outside at least one part of the wrong assembly member when the wrong assembly member is accommodated therein, and moving the wrong assembly member in an interference direction of the interference portion with the wrong member.

14. The assembly failure prevention device according to claim 13, further comprising second regulating means provided on the passing track of the belt member, for interfering with the belt member which is about to pass through the predetermined position when the support body supporting the assembly member has not yet reached the predetermined position, such that the belt member is prevented from passing through the predetermined position.

15. The assembly failure prevention device according to claim 14, wherein the second regulating means includes a regulating member provided on the passing track of the belt member, the regulating member being moved out of the passing track by being pressed by the assembly member moving to the predetermined position.

16. The assembly failure prevention device according to claim 12, further comprising second regulating means provided on the passing track of the belt member, for interfering with the belt member which is about to pass through the predetermined position when the support body supporting the assembly member has not yet reached the predetermined position, such that the belt member is prevented from passing through the predetermined position.

17. The assembly failure prevention device according to claim 16, wherein the second regulating means includes a regulating member provided on the passing track of the belt member, the regulating member being moved out of the passing track by being pressed by the assembly member moving to the predetermined position.

18. The assembly failure prevention device according to claim 2, further comprising second regulating means provided on the passing track of the belt member, for interfering with the belt member which is about to pass through the predetermined position when the support body supporting the assembly member has not yet reached the predetermined position, such that the belt member is prevented from passing through the predetermined position.

19. The assembly failure prevention device according to claim 18, wherein the second regulating means includes a regulating member provided on the passing track of the belt member, the regulating member being moved out of the passing track by being pressed by the assembly member moving to the predetermined position.

20. The assembly failure prevention device according to claim 1, further comprising second regulating means provided on the passing track of the belt member, for interfering with the belt member which is about to pass through the predetermined position when the support body supporting the assembly member has not yet reached the predetermined position, such that the belt member is prevented from passing through the predetermined position.

21. The assembly failure prevention device according to claim 20, wherein the second regulating means includes a regulating member provided on the passing track of the belt member, the regulating member being moved out of the passing track by being pressed by the assembly member moving to the predetermined position.

22. An assembly failure prevention device used in an assembling process of assembling an assembly member onto a belt member by inserting the belt member into the assembly member having insertion holes for inserting the belt member, comprising:
(second) regulating means provided on the passing track of the belt member, for interfering with the belt member in a state in which the assembly member has not yet reached a predetermined position on the passing track, such that, as a result of the interference with the belt member, the belt member is prevented from passing through the predetermined position.

23. An assembly failure prevention device according to claim 22, wherein the second regulating means includes a regulating member provided on the passing track of the belt member, the regulating member being moved out of the passing track by being pressed by the assembly member moving to the predetermined position.
